(19) United States
(12) Patent Application Publication
(10) Pub. No.: US 2005/0068906 A1
(43) Pub. Date: Mar. 31, 2005

(54) Method and system for group communications in a wireless communications system

(76) Inventor: David L. Muri, Sunrise, FL (US)

Correspondence Address: MOTOROLA, INC., 1303 EAST ALGONQUIN ROAD, IL01/3RD, SCHAUMBURG, IL, 60196, US

(21) Appl. No.: 10/674,924

(22) Filed: Sep. 30, 2003

(51) Int. Cl. H04L 12/16; H04B 7/00; H04Q 7/00

(52) U.S. Cl. 370/260; 370/277; 370/328

(57) ABSTRACT

Apparatus (50) for enabling group duplex communication in a wireless communications system (100) that includes a receiving device for receiving a first (14), second (24) and third (34) individual encoded voice signal from a first (10), second (20) and third (30) communications unit a over corresponding first (12), second (22) and third (32) communications resources, the first, second and third encoded signals being a function of respective first, second and third original voice signals; a processing device for generating at least one combined voice signal (80) that is a function of the first, second and third original voice signals, and generating at least one combined encoded voice signal (90) from the at least one combined voice signal; and a transmitting device for transmitting the at least one combined encoded voice signal to the first, second and third communications units over corresponding outbound wireless communications resources (18, 28, 38).

### FIELD OF THE INVENTION

The present invention relates generally to communications systems and more specifically to duplex communication with more than two participants.

### BACKGROUND OF THE INVENTION

In a communications system a duplex call may be placed. Full duplex operation is desired because it is the ultimate in communication and it is available in telephonic communication. For instance, in a Frequency Division Multiple Access (FDMA) system, a duplex call is typically made between two participants or users in the system. In this mode of operation, the participants transmit and receive signals at the same time without having to take turns as in a simplex call.

In a Time Division Multiple Access (TDMA) system, a duplex call is typically made between two participants or users in the system. In this mode of operation, the two participants transmit to each other in differing slots of time, such that they seemingly transmit and receive signals at the same time without having to take turns in talking to each other as in a simplex call.

However, in either the FDMA or TDMA instance, there may be times where it is desired that more than two users participate in a duplex call.

Thus, there exists a need in a wireless communications system for a more effective method and apparatus for enabling duplex communication between more than two participants, also referred to herein as “group duplex” communication.

### BRIEF DESCRIPTION OF THE FIGURES

A preferred embodiment of the invention is now described, by way of example only, with reference to the accompanying figures in which:

FIG. 1 illustrates a wireless communications system adapted for group duplex communications in accordance with one embodiment of the present invention; and

FIG. 2 illustrates a wireless communications system adapted for group duplex communications in accordance with another embodiment of the present invention.

### DETAILED DESCRIPTION OF THE PREFERRED EMBODIMENT

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

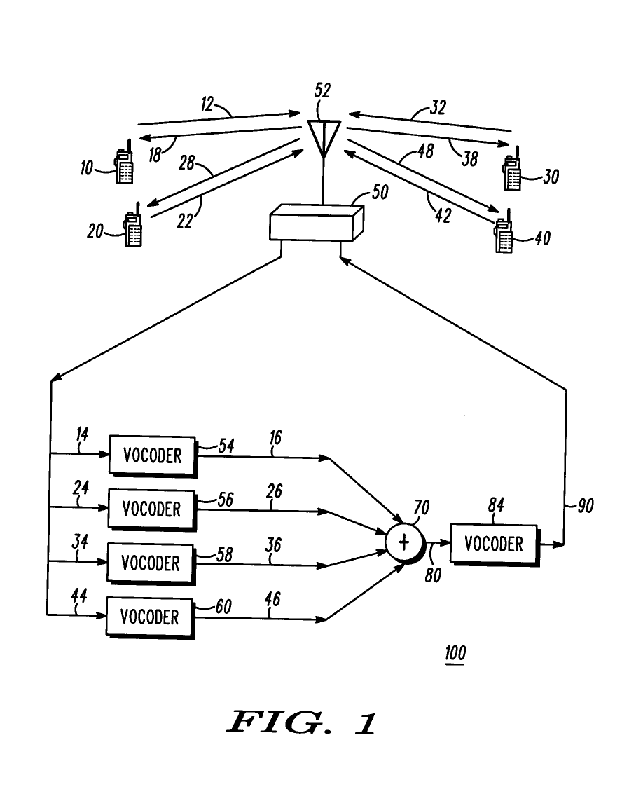

FIG. 1 illustrates a wireless communications system 100 adapted for group duplex communications in accordance with one embodiment of the present invention. System 100 may be any of a number of conventional communications systems including a Time Division Multiple Access (“TDMA”) system, a Frequency Division Multiple Access (“FDMA”) system, or a Code Division Multiple Access (“CDMA”) system.

System 100 includes communications units 10, 20, 30 and 40. In one embodiment, communications units 10, 20, 30 and 40 are conventional subscriber units that are adapted for TDMA duplex operation. Communications units 10, 20, 30 and 40 transmit and receive voice signals generated by respective users speaking into the units. Communications units 10, 20, 30 and 40 each typically comprises a transmitter and receiver means or devices such as, for instance, a transceiver unit, a digital signal processor (“DSP”), a microphone, a speaker, an antenna, and a voice coder that is typically implemented in software in a processing unit such as, for instance, the DSP of the communications unit. During a transmit mode, the communications unit receives an original voice signal or waveform into its microphone, wherein the voice coder encodes the original voice signal using conventional means such as, for instance, VSELP (vector sum excited linear prediction), AMBE (advanced multi-band excitation), LPC (linear predictive coding), and IMBE (improved multi-band excitation), to generate an encoded voice signal that is then transmitted by the transceiver unit to another communications unit via the antenna. During the receive mode, the transceiver of the communications unit receives, via the antenna, an encoded signal that is based on an original voice signal spoken into a different communications unit. This received encoded signal is then decoded in the voice coder, using conventional means such as, for instance, VSELP, AMBE, LPC and IMBE, to recover at least a portion of the original voice signal spoken into the other communications unit.

Those of ordinary skill in the art realize that communications units 10, 20, 30 and 40 may alternately be adapted for FDMA duplex operation or CDMA duplex operation. In addition, four communication units are shown in FIG. 1 for ease of illustration. However, it is appreciated that many more subscriber units would typically be coupled to communications system 100. Moreover, group duplex communication in accordance with the present invention may include as few as three communications units.

System 100 further includes a repeater 50 adapted for receiving individual encoded voice signals 14, 24, 34 and 44 from communications units 10, 20, 30 and 40, respectively, over wireless communications resources 12, 22, 32 and 42 via an antenna 52 that is coupled to repeater 50. Repeater 50 is further adapted for transmitting individual encoded voice signals to communications units 10, 20, 30 and 40, respectively, over wireless communications resources 18, 28, 38 and 48 via antenna 52 using techniques known in the art. Repeater 50 is also adapted for transmitting encoded combined voice signals to communications units 10, 20, 30 and 40, respectively, over wireless communications resources 18, 28, 38 and 48 via antenna 52 using techniques in accordance with the present invention.

In a TDMA system, wireless communications resources 12, 22, 32 and 42 are inbound time slots on a single frequency, and wireless communications resources 18, 28, 38 and 48 are outbound time slots on a single frequency. In an FDMA system, wireless communications resources 12, 22, 32 and 42 are typically a plurality of corresponding inbound frequencies, and wireless communications resources 18, 28, 38 and 48 are typically a plurality of corresponding outbound frequencies. In a CDMA system, wireless communications resources 12, 22, 32 and 42 are orthogonal spreading codes on a single inbound frequency, and wireless communications resources 18, 28, 38 and 48 are orthogonal spreading codes on a single outbound frequency.

Repeater 50 comprises antenna 52, a transmitter and receiver means or devices (not shown) such as, for instance, a transceiver unit, and a DSP. Repeater 50 also comprises, voice coders 54, 56, 58 and 60 for receiving encoded signals 14, 24, 34 and 44 from communications units 10, 20, 30 and 40, respectively, and placing those signals in a format for being added together. The output signals from the voice coders are represented, respectively, as signals 16, 26, 36 and 46. In the embodiment of the present invention illustrated in FIG. 1, voice coders 54, 56, 58 and 60 are each represented as hardware units and the number of voice coders corresponds to the number of communications units coupled to repeater 50. However, it is appreciated by those of ordinary skill in the art that the functionality of voice coders 54, 56, 58 and 60 is typically performed in software in a processing unit such as, for instance, the DSP of repeater 50.

Repeater 50 further includes a summing junction 70 for combining voice signals 16, 26, 36 and 46 from the voice coders into a combined voice signal 80. Summing junction 70 may be implemented in hardware using a conventional means such as, for instance, such as an operational amplifier, but is typically implemented in software such as, for instance, in the repeater's DSP. Finally, voice coder 84 places combined signal 80 in a format for being transmitted to communications units 10, 20, 30 and 40, respectively, over communications resources 18, 28, 38 and 38. The combined signal is represented as a signal 90. Voice coder 84 may likewise be implemented in hardware but is typically implemented in software such as, for instance, in the repeater's DSP.

System 100 is illustrated as having one repeater 50, however it is appreciated that the communications system typically has a plurality of repeater units. It is also appreciated that repeater 50 performs additional conventional processing functions such as, for instance, modulation, FEC (forward error correction), interleaving, etc. Moreover, it is realized by those of ordinary skill in the art that communications system 100 may also include other elements such as, for instance, routers, console interfaces, and PSTN (public switched telephone network) interfaces.

In a TDMA system, system 100 performs group duplex communications as follows in accordance with another embodiment of the present invention. Communications units 10, 20, 30 and 40 generate individual encoded voice signals 14, 24, 34 and 44 based on four originals voice signals or waveforms (not shown) generated by users speaking into the respective microphones of the communications units. Communications units 10, 20, 30 and 40 then respectively transmit individual encoded voice signals 14, 24, 34 and 44 to repeater 50 over respective inbound time slots 12, 22, 32 and 42 of a single frequency. Signals 14, 24, 34 and 44 are typically digital signals. Voice coders 54, 56, 58 and 60 receive individual encoded voice signals 14, 24, 34 and 44, respectively, and translate (or decode using conventional means such as, for instance, VSELP, AMBE, LPC and IMBE) those digital signals to generate corresponding digital or analog representations 16, 26, 36 and 46 of an approximation of the original speech waveforms. Signals 16, 26, 36 and 46 may be, for instance, pulse code modulated (“PCM”) representations of the original speech waveform or may be any other digital or analog representation of the original speech waveform that is in a format for being summed to generate a combined voice signal.

Summing junction 70 combines signals 16, 26, 36 and 46 into a combined voice signal 80. Voice coder 84 then receives signal 80 and translates (or encodes using conventional means such as, for instance, VSELP, AMBE, LPC and IMBE) signal 80 into a format such as, for instance, a compressed digital signal (i.e., signal 90) that may be transmitted to communications units 10, 20, 30 and 40. Repeater 50 then transmits encoded signal 90 via antenna 52 to communications units 10, 20, 30 and 40, respectively, over outbound time slots 18, 28, 38 and 48 of a single frequency.

The TDMA system illustrated herein is a four slot TDMA system having four inbound time slots per inbound frequency and four corresponding outbound time slots per outbound frequency. However, it is understood by those of ordinary skill in the art, that the system may alternatively be a six slot TDMA system, an eight slot TDMA system or any other conventional TDMA system.

In an alternative embodiment, system 100 is an FDMA system. Communications units 10, 20, 30 and 40 generate individual encoded voice signals 14, 24, 34 and 44 based on four originals voice signals or waveforms generated by users speaking into the respective microphones of the communications units. Communications units 10, 20, 30 and 40 then respectively transmit individual encoded voice signals 14, 24, 34 and 44 to repeater 50 over respective inbound frequencies 12, 22, 32 and 42. Frequencies 12, 22, 32 and 42 are typically a combination of different inbound frequencies. Signals 14, 24, 34 and 44 are typically digital signals. Voice coders 54, 56, 58 and 60 receive individual encoded voice signals 14, 24, 34 and 44, respectively, and translates those digital signals into corresponding conventional digital or analog representations 16, 26, 36 and 46 of an approximation of the original speech waveforms that are in a format for being be summed to generate a combined voice signal.

Summing junction 70 combines signals 16, 26, 36 and 46 into a combined signal 80. Voice coder 84 then receives signal 80 and translates or encodes it into format such as, for instance, a compressed digital signal (i.e., signal 90) that may be transmitted to communications units 10, 20, 30 and 40. Repeater 50 may then transmit encoded signal 90 via antenna 52 to communications units 10, 20, 30 and 40, respectively, over outbound frequencies 18, 28, 38 and 48. Outbound frequencies 18, 28, 38 and 48 are typically a combination of different frequencies.

In yet another embodiment, system 100 is a CDMA system. Communications units 10, 20, 30 and 40 generate individual encoded voice signals 14, 24, 34 and 44 based on four originals voice signals or waveforms generated by users speaking into the respective microphones of the communications units. Communications units 10, 20, 30 and 40 then respectively transmit individual encoded voice signals 14, 24, 34 and 44 to repeater 50 using respective orthogonal spreading codes 12, 22, 32 and 42 over a single inbound frequency. Signals 14, 24, 34 and 44 are typically digital signals. Voice coders 54, 56, 58 and 60 receive individual encoded voice signals 14, 24, 34 and 44, respectively, and translate those digital signals into corresponding digital or analog representations 16, 26, 36 and 46 of an approximation of the original speech waveforms.

Summing junction 70 combines signals 16, 26, 36 and 46 into a combined voice signal 80. Voice coder 84 then receives signal 80 and translates or encodes it into a format such as, for instance, a compressed digital signal (i.e., signal 90) that may be transmitted to communications units 10, 20, 30 and 40. Repeater 50 then transmits encoded signal 90 via antenna 52 to communications units 10, 20, 30 and 40 using respective orthogonal spreading codes 18, 28, 38 and 48 over a single outbound frequency.

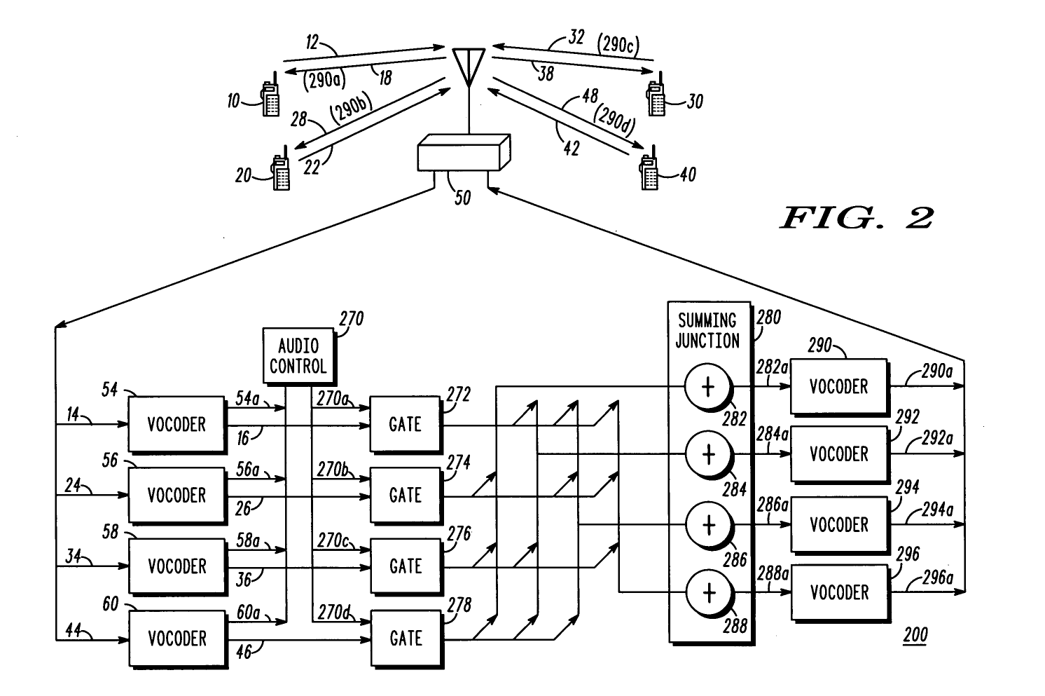

FIG. 2 illustrates a wireless communications system 200 adapted for group duplex communications in accordance with another embodiment of the present invention. Those elements that are identical to the elements illustrated in FIG. 1 are correspondingly identically labeled in FIG. 2. Wireless communications system 200 includes communications units 10, 20, 30 and 40. In one embodiment, communications units 10, 20, 30 and 40 are conventional subscriber units that are adapted for TDMA duplex operation. Communications units 10, 20, 30 and 40 transmit and receive voice signals generated by respective users speaking into the units. Those of ordinary skill in the art will realize that communications units 10, 20, 30 and 40 may alternately be adapted for FDMA duplex operation or CDMA duplex operation. In addition, four communication units are shown in FIG. 1 for ease of illustration. However, it is appreciated that many more subscriber units would typically be coupled to communications system 200. Moreover, group duplex communication in accordance with the present invention may include as few as three communications units.

System 100 further includes a repeater 50 adapted for receiving individual encoded voice signals 14, 24, 34 and 44 from communications units 10, 20, 30 and 40, respectively, over wireless communications resources 12, 22, 32 and 42 via an antenna 52 that is coupled to repeater 50. Repeater 50 is further adapted for transmitting individual encoded voice signals to communications units 10, 20, 30 and 40, respectively, over wireless communications resources 18, 28, 38 and 48 via antenna 52 using techniques known in the art. Repeater 50 is also adapted for transmitting combined encoded voice signals, e.g., 290a, 292a, 294a and 296a, to communications units 10, 20, 30 and 40, respectively, over wireless communications resources 18, 28, 38 and 48 via antenna 52, using techniques in accordance with the present invention.

In a TDMA system, wireless communications resources 12, 22, 32 and 42 are inbound time slots on a single frequency, and wireless communications resources 18, 28, 38 and 48 are outbound time slots on a single frequency. In an FDMA system, wireless communications resources 12, 22, 32 and 42 are typically a plurality of corresponding inbound frequencies, and wireless communications resources 18, 28, 38 and 48 are typically a plurality of corresponding outbound frequencies. In a CDMA system, wireless communications resources 12, 22, 32 and 42 are orthogonal spreading codes on a single inbound frequency, and wireless communications resources 18, 28, 38 and 48 are orthogonal spreading codes on a single outbound frequency.

Repeater 50 comprises antenna 52, a transmitter and receiver means or devices such as, for instance, a transceiver unit, and a DSP. Repeater 50 also comprises, voice coders 54, 56, 58 and 60 for receiving signals 14, 24, 34 and 44 from communications units 10, 20, 30 and 40, respectively and placing those signals in a format for being added together. The output signals from the voice coders are represented respectively as signals 16, 26, 36 and 46. In the embodiment of the present invention illustrated in FIG. 2, voice coders 54, 56, 58 and 60 are each represented as hardware units and the number of voice coders corresponds to the number of communications units coupled to repeater 50. However, it is appreciated by those of ordinary skill in the art that the functionality of voice coders 54, 56, 58 and 60 is typically performed in software in a processing unit such as, for instance, the DSP of repeater 50.

Repeater 50 further includes an audio control device or means 270, gates 272, 274, 276 and 278 and a summing junction 280 that includes summing junctions 282, 284, 286 and 288 for combining individual voice signals 16, 26, 36 and 46 from the voice coders into respective combined voice signals 282a, 284a, 286a and 288a. Audio control device 270, gates 272, 274, 276 and 278, and summing junction 280 may be implemented in hardware but are typically implemented in software such as, for instance, in the repeater's DSP. Finally, repeater 50 includes voice coders 290, 292, 294 and 296 that place combined signals 282a, 284a, 286a and 288a into a format for being transmitted to communications units 10, 20, 30 and 40. The outputs of voice coders 290, 292, 294 and 296 are respectively represented as signals 290a, 292a, 294a and 296a. Voice coders 290, 292, 294 and 296 may likewise be implemented in hardware but are typically implemented in software such as, for instance, in the repeater's DSP.

In a TDMA system, system 200 performs group duplex communications as follows in accordance with another embodiment of the present invention. Communications units 10, 20, 30 and 40 generate individual encoded voice signals 14, 24, 34 and 44 based on four originals voice signals or waveforms generated by users speaking into the respective microphones of the communications units. Communications units 10, 20, 30 and 40 then respectively transmit individual encoded voice signals 14, 24, 34 and 44 to repeater 50 over respective inbound time slots 12, 22, 32 and 42 of a single frequency. Signals 14, 24, 34 and 44 are typically digital signals. Voice coders 54, 56, 58 and 60 receive individual encoded voice signals 14, 24, 34 and 44 and, respectively, translates those digital signals into corresponding representations 16, 26, 36 and 46 of an approximation the original speech waveforms. Signals 16, 26, 36 and 46 may be, for instance, pulse code modulated (“PCM”) representations of the original speech waveform or may be any other digital or analog representation of the original speech waveform that is in a format for being be summed to generate one or more combined voice signals. Voice coders 54, 56, 58 and 60 are also adapted for detecting the level or strength of speech in a voice signal, for instance, through the use of a voice activity detector (“VAD”) or any other conventional voice activity level detection means, wherein a higher VAD number indicates a higher confidence in the presence of speech and a lower VAD number indicates a lower confidence in the presence of speech. Voice coders 54, 56, 58 and 60 are, therefore, accordingly adapted to generate respective voice activity level signals 54a, 56a, 58a and 60a.

Audio control unit 270 compares voice activity signals 54a, 56a, 58a and 60a to a threshold to determine whether the signals are at a high enough level (e.g., strong enough) to be included in one or more combined voice signals. The threshold may be predetermined or may be dynamically determined as a function of one or more factors such as, for instance, the voice activity level signals 54a, 56a, 58a and 60a. If a voice activity signal is at or exceeds the threshold, audio control unit 270 signals the corresponding gate to allow the voice signal, or a portion of the voice signal, through to the summing junction 280 to be included in one or more combined voice signals. Alternatively, if the voice activity signal falls below the threshold, audio control unit 270 signals the corresponding gate to prevent the signal from being forwarded to the summing junction 280. Audio control unit 270 signals gates 272, 274, 276 and 278, respectively, through signals 270a, 270b, 270c and 270d.

Summing junction 280 combines signals 16, 26, 36 and 46 into one or more combined voice signals 282a, 284a, 286a and 288a, respectively, using summing junctions 282, 284, 286 and 288. In an exemplary embodiment of the present invention, summing junction 282 is adapted to exclude individual voice signal 16 from combined voice signal 282a to increase the voice quality of combined voice signal 282a. In this manner, the user of communications unit 10 who hears a representation of combined voice signal 282a will not hear his own voice but will only hear the voices of the other users whose corresponding voice signals exceeded the voice activity level threshold. Likewise, summing junction 284 is adapted to exclude individual voice signal 26 from combined voice signal 284a. Summing junction 286 is adapted to exclude individual voice signal 36 from combined voice signal 286a, and summing junction 288 is adapted to exclude individual voice signal 46 from combined voice signal 288a.

Voice coders 290, 292, 294 and 296 then, respectively, receive combined voice signals 280a, 284a, 286a and 288a and translates or encodes those signals into a format such as, for instance, compressed digital signals (i.e., respective signals 290a, 292a, 294a and 296a) that may be transmitted, respectively, to communications units 10, 20, 30 and 40. Repeater 50 then transmits encoded signals 290a, 292a, 294a and 296a via antenna 52, respectively, to communications units 10, 20, 30 and 40 over outbound time slots 18, 28, 38 and 48 of a single frequency.

In an alternative embodiment, system 100 is an FDMA system. Communications units 10, 20, 30 and 40 generate individual encoded voice signals 14, 24, 34 and 44 based on four originals voice signals or waveforms generated by users speaking into the respective microphones of the communications units. Communications units 10, 20, 30 and 40 then respectively transmit individual voice signals 14, 24, 34 and 44 to repeater 50 over respective inbound frequencies 12, 22, 32 and 42. Frequencies 12, 22, 32 and 42 are typically a combination of different frequencies. Signals 14, 24, 34 and 44 are typically digital signals. Voice coders 54, 56, 58 and 60, respectively, receive individual encoded voice signals 14, 24, 34 and 44 and translates those digital signals into corresponding digital or analog representations 16, 26, 36 and 46 of an approximation of the original speech waveforms that are in a format for being summed to generate a combined voice signal. Voice coders 54, 56, 58 and 60 are also adapted for detecting the level or strength of speech in a voice signal, for instance, through the use of a voice activity detector (“VAD”) or any other conventional voice activity level detection means, wherein a higher VAD number indicates a higher confidence in the presence of speech and a lower VAD number indicates a lower confidence in the presence of speech. Voice coders 54, 56, 58 and 60 are, therefore, accordingly adapted to generate respective voice activity level signals 54a, 56a, 58a and 60a.

Audio control unit 270 compares voice activity signals 54a, 56a, 58a and 60a to a threshold to determine whether the signals are at a high enough level (e.g., strong enough) to be included in one or more combined voice signals. The threshold may be predetermined or may be dynamically determined as a function of one or more factors such as, for instance, the voice activity level signals 54a, 56a, 58a and 60a. If a voice activity signal is at or exceeds the threshold, audio control unit 270 signals the corresponding gate to allow the voice signal, or a portion of the voice signal, through to the summing junction 280 to be included in one or more combined voice signals. Alternatively, if the voice activity signal falls below the threshold, audio control unit signals the corresponding gate to prevent the voice signal from being forwarded to the summing junction 280. Audio control unit 270 signals gates 272, 274, 276 and 278, respectively, through signals 270a, 270b, 270c and 270d.

Summing junction 280 combines signals 16, 26, 36 and 46 into one or more combined voice signals 282a, 284a, 286a and 288a, respectively, using summing junctions 282, 284, 286 and 288. In an exemplary embodiment of the present invention, summing junction 282 is adapted to exclude individual voice signal 16 from combined voice signal 282a to increase the voice quality of combined voice signal 282a. In this manner, the user of communications unit 10 who hears a representation of combined voice signal 282a will not hear his own voice but will hear only the voices of the other users whose corresponding voice signals exceeded the voice activity level threshold. Likewise, summing junction 284 is adapted to exclude individual voice signal 26 from combined voice signal 284a. Summing junction 286 is adapted to exclude individual voice signal 36 from combined voice signal 286a, and summing junction 288 is adapted to exclude individual voice signal 46 from combined voice signal 288a.

Voice coders 290, 292, 294 and 296 then, respectively, receive combined voice signals 282a, 284a, 286a and 288a and translates or encodes those signals into a format such as, for instance, a compressed digital signal (i.e., respective signals 290a, 292a, 294a and 296a) that may be transmitted, respectively, to communications units 10, 20, 30 and 40. Repeater 50 then transmits signals 290a, 292a, 294a and 296a via antenna 52, respectively, to communications units 10, 20, 30 and 40 over outbound frequencies 18, 28, 38 and 48 that are typically a combination of different frequencies.

In yet another embodiment, system 100 is a CDMA system. Communications units 10, 20, 30 and 40 generate individual encoded voice signals 14, 24, 34 and 44 based on four originals voice signals or waveforms generated by users speaking into the respective microphones of the communications units. Communications units 10, 20, 30 and 40 then respectively transmit individual voice signals 14, 24, 34 and 44 to repeater 50 using respective orthogonal spreading codes 12, 22, 32 and 42 over a single inbound frequency. Signals 14, 24, 34 and 44 are typically digital signals. Voice coders 54, 56, 58 and 60, respectively, receive individual encoded voice signals 14, 24, 34 and 44 and translates those digital signals into corresponding digital or analog representations 16, 26, 36 and 46 of an approximation of the original speech waveforms that are in a format for being summed to generate a combined voice signal. Voice coders 54, 56, 58 and 60 are also adapted for detecting the level or strength of speech in a voice signal, for instance, through the use of a voice activity detector (“VAD”) or any other conventional voice activity level detection means, wherein a higher VAD number indicates a higher confidence in the presence of speech and a lower VAD number indicates a lower confidence in the presence of speech. Voice coders 54, 56, 58 and 60 are, therefore, accordingly adapted to generate respective voice activity level signals 54a, 56a, 58a and 60a.

Audio control unit 270 compares voice activity signals 54a, 56a, 58a and 60a to a threshold to determine whether the signals are at a high enough level (e.g., strong enough) to be included in one or more combined voice signals. The threshold may be predetermined or may be dynamically determined as a function of one or more factors such as, for instance, the voice activity level signals 54a, 56a, 58a and 60a. If a voice activity signal is at or exceeds the threshold, audio control unit 270 signals the corresponding gate to allow the voice signal, or a portion of the voice signal, through to the summing junction 280 to be included in one or more combined voice signals. Alternatively, if the voice activity signal falls below the threshold, audio control unit signals the corresponding gate to prevent the voice signal from being forwarded to the summing junction 280. Audio control unit 270 signals gates 272, 274, 276 and 278, respectively, through signals 270a, 270b, 270c and 270d.

Summing junction 280 combines signals 16, 26, 36 and 46 into one or more combined voice signals 282a, 284a, 286a and 288a, respectively, using summing junctions 282, 284, 286 and 288. In an exemplary embodiment of the present invention, summing junction 282 is adapted to exclude individual voice signal 16 from combined voice signal 282a to increase the voice quality of combined voice signal 282a. In this manner, the user of communications unit 10 who hears a representation of combined voice signal 282a will not hear his own voice but will hear only the voices of the other users whose corresponding voice signals exceeded the voice activity level threshold. Likewise, summing junction 284 is adapted to exclude individual voice signal 26 from combined voice signal 284a. Summing junction 286 is adapted to exclude individual voice signal 36 from combined voice signal 286a, and summing junction 288 is adapted to exclude individual voice signal 46 from combined voice signal 288a.

Voice coders 290, 292, 294 and 296 then, respectively, receive combined voice signals 282a, 284a, 286a and 288a and translates or encodes those signals into a format such as, for instance, a compressed digital signal (i.e., respective signals 290a, 292a, 294a and 296a) that may be transmitted, respectively, to communications units 10, 20, 30 and 40. Repeater 50 then transmits signals 290a, 292a, 294a and 296a via antenna 52, respectively, to communications units 10, 20, 30 and 40 using corresponding orthogonal spreading codes 18, 28, 38 and 48 over a single outbound frequency.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. Apparatus for enabling group communications in a wireless communications system that includes a first communications unit, a second communications unit, and at least a third communications unit, said apparatus comprising:
a receiving device for receiving a first individual encoded voice signal from a first communications unit over a first inbound wireless communications resource, said first encoded signal being a function of a first original voice signal, receiving a second individual encoded voice signal from a second communications unit over a second inbound wireless communications resource, said second encoded signal being a function of a second original voice signal, and receiving at least a third individual encoded voice signal from a third communications unit over a third inbound wireless communications resource, said third encoded signal being a function of a third original voice signal;
a processing device adapted for performing an algorithm for generating at least one combined voice signal that is a function of said first, second and third original voice signals, and generating at least one combined encoded voice signal from said at least one combined voice signal; and
a transmitting device for transmitting said at least one combined encoded voice signal to said first, second and third communications units over corresponding outbound wireless communications resources.

2. The apparatus of claim 1, wherein said processing unit is further adapted for performing an algorithm for generating:
a first representation of an approximation of said first original voice signal;
a second representation of an approximation of said second original voice signal; and
a third representation of an approximation of said third original voice signal, and wherein said at least one combined voice signal is a function of at least a portion of said first, second and third representations.

3. The apparatus of claim 2, wherein said processing unit comprises a first, second and third voice coder and wherein said first representation is generated in said first voice coder, said second representation is generated in said second voice coder, and said third representation is generated in said third voice coder.

4. The apparatus of claim 2, wherein said first, second and third representations are pulse code modulated representations of said corresponding first, second and third original voice signals.

5. The apparatus of claim 2, wherein said processing unit is further adapted for performing an algorithm for selecting the representations to be included in each said combined voice signals based on whether the representation has a corresponding speech activity level that exceeds a first threshold.

6. The apparatus of claim 5, wherein said first threshold is predetermined.

7. The apparatus of claim 5, wherein said first threshold is dynamically determined based on at least one factor.

8. The apparatus of claim 2, wherein said processing unit is further adapted for performing an algorithm for generating:
a first combined encoded voice signal that is exclusive of said first representation, to be transmitted to said first communications unit;
a second combined encoded voice signal that is exclusive of said second representation, to be transmitted to said second communications unit; and
a third combined encoded voice signal that is exclusive of said third representation, to be transmitted to said third communications unit.

9. The apparatus of claim 1, wherein said apparatus is included in a repeater.

10. The apparatus of claim 1, wherein said processing unit is a digital signal processor.

11. The apparatus of claim 1, wherein said wireless communications system is a Time Division Multiple Access (“TDMA”) system and wherein:
said first individual encoded voice signal is received in a first inbound time slot over a first frequency;
said second individual encoded voice signal is received in a second inbound time slot over said first frequency;
said third individual encoded voice signal is received in a third inbound time slot over said first frequency; and
said at least one combined encoded voice signal is transmitted to said first, second and third communications units in a set of corresponding separate outbound time slots over a second frequency.

12. The apparatus of claim 11, wherein, said TDMA system is a four-slot TDMA system.

13. The apparatus of claim 1, wherein said wireless communications system is a Frequency Division Multiple Access (“FDMA”) system and wherein:
said first individual encoded voice signal is received over a first inbound frequency;
said second individual encoded voice signal is received over a second inbound frequency;
said third individual encoded voice signal is received over a second inbound frequency; and
said at least one combined encoded voice signal is transmitted to said first, second and third communications units over a set of corresponding separate outbound frequencies.

14. The apparatus of claim 1, wherein said wireless communications system is a Code Division Multiple Access (“CDMA”) system and wherein:
said first individual encoded voice signal is received in a first orthogonal spreading code over an inbound frequency;
said second individual encoded voice signal is received in a second orthogonal spreading code over said inbound frequency;
said third individual encoded voice signal is received in a third orthogonal spreading code over said inbound frequency; and
said at least one combined encoded voice signal is transmitted to said first, second and third communications units in a set of corresponding orthogonal spreading codes over an outbound frequency.

15. Apparatus for enabling group communications in a wireless communications system that includes a first communications unit, a second communications unit, and at least a third communications unit, said apparatus comprising:
a receiving device for receiving a first individual encoded voice signal from a first communications unit over a first wireless communications resource, said first encoded signal being a function of a first original voice signal, receiving a second individual encoded voice signal from a second communications unit over a second wireless communications resource, said second encoded signal being a function of a second original voice signal, and receiving at least a third individual encoded voice signal from a third communications unit over a third wireless communications resource, said third encoded signal being a function of a third original voice signal;
a processing device adapted for performing an algorithm for generating a first representation of an approximation of said first original voice signal, generating a second representation of an approximation of said second original voice signal, generating a third representation of an approximation of said third original voice signal, selecting the representations to be included in at least one combined voice signal based on whether the representation has a corresponding speech activity level that exceeds a first threshold, generating said at least one combined voice signal as a function of at least a portion of said first, second and third representations, and generating at least one combined encoded voice signal from said at least one combined voice signal; and
a transmitting means for transmitting said at least one combined encoded voice signal to said first, second and third communications units over corresponding outbound communications resources.

16. Apparatus for enabling group communications in a TDMA wireless communications system that includes a first communications unit, a second communications unit, and at least a third communications unit, said apparatus comprising:
a receiving device for receiving a first individual encoded voice signal from a first communications unit in a first inbound time slot over a first frequency, said first encoded signal being a function of a first original voice signal, receiving a second individual encoded voice signal from a second communications unit in a second inbound time slot over said first frequency, said second encoded signal being a function of a second original voice signal, and receiving at least a third individual encoded voice signal from a third communications unit in a third inbound time slot over said first frequency, said third encoded signal being a function of a third original voice signal;
a processing device adapted for performing an algorithm for generating a first representation of an approximation of said first original voice signal, generating a second representation of an approximation of said second original voice signal, generating a third representation of an approximation of said third original voice signal, selecting the representations to be included in at least one combined voice signal, that is a function of at least a portion of said first, second and third representations, based on whether the representation has a corresponding speech activity level that exceeds a first threshold, generating a first combined voice signal that is exclusive of said first representation, generating a second combined voice signal that is exclusive of said second representation, generating a third combined voice signal that is exclusive of said third representation, and generating a first, second and third combined encoded voice signal from said first second and third combined voice signals; and
a transmitting means for transmitting said first, second and third combined encoded voice signals, respectively, to said first, second and third communications units in corresponding outbound time slots over a second frequency.

17. A method for enabling group communications in a wireless communications system that includes a first communications unit, a second communications unit, and at least a third communications unit, said method comprising the steps of:
receiving a first individual encoded voice signal from a first communications unit over a first inbound wireless communications resource, said first encoded signal being a function of a first original voice signal;
receiving a second individual encoded voice signal from a second communications unit over a second inbound wireless communications resource, said second encoded signal being a function of a second original voice signal;
receiving at least a third individual encoded voice signal from a third communications unit over a third inbound wireless communications resource, said third encoded signal being a function of a third original voice signal;
generating at least one combined voice signal that is a function of said first, second and third original voice signals;
generating at least one combined encoded voice signal from said at least one combined voice signal; and
transmitting said at least one combined encoded voice signal to said first, second and third communications units over corresponding outbound wireless communications resources.

18. The method of claim 17, wherein said wireless communications system is a Time Division Multiple Access (“TDMA”) system and wherein:
said first individual encoded voice signal is received in a first inbound time slot over a first frequency;
said second individual encoded voice signal is received in a second inbound time slot over said first frequency;
said third individual encoded voice signal is received in a third inbound time slot over said first frequency; and
said at least one combined encoded voice signal is transmitted to said first, second and third communications units in a set of corresponding separate outbound time slots over a second frequency.

19. The method of claim 17, wherein said wireless communications system is a Frequency Division Multiple Access (“FDMA”) system and wherein:
said first individual encoded voice signal is received over a first inbound frequency;
said second individual encoded voice signal is received over a second inbound frequency;
said third individual encoded voice signal is received over a second inbound frequency; and
said at least one combined encoded voice signal is transmitted to said first, second and third communications units over a set of corresponding separate outbound frequencies.

20. The apparatus of claim 17, wherein said wireless communications system is a Code Division Multiple Access (“CDMA”) system and wherein:
said first individual encoded voice signal is received in a first orthogonal spreading code over an inbound frequency;
said second individual encoded voice signal is received in a second orthogonal spreading code over said inbound frequency;
said third individual encoded voice signal is received in a third orthogonal spreading code over said inbound frequency; and
said at least one combined encoded voice signal is transmitted to said first, second and third communications units in a set of corresponding orthogonal spreading codes over an outbound frequency.

21. The method of claim 17 further comprising the steps of:
generating a first representation of an approximation of said first original voice signal;
generating a second representation of an approximation of said second original voice signal; and
generating a third representation of an approximation of said third original voice signal, and wherein said at least one combined voice signal is a function of at least a portion of said first, second and third representations.

22. The method of claim 21, wherein said first, second and third representations are pulse code modulated representations of said corresponding first, second and third original voice signals.

23. The method of claim 21 further comprising the step of selecting the representations to be included in each said combined voice signals based on whether the representation has a corresponding speech activity level that exceeds a first threshold.

24. The method of claim 23, wherein said first threshold is predetermined.

25. The method of claim 23, wherein said first threshold is dynamically determined based on at least one factor.
